(19) United States
(12) Patent Application Publication
(10) Pub. No.: US 2012/0251168 A1
(43) Pub. Date: Oct. 4, 2012

(54) ELECTROPHOTOGRAPHIC IMAGE FORMING METHOD AND PROCESS CARTRIDGE

(76) Inventors: Masashi Nagayama, Shizuoka (JP); Mitsuo Aoki, Shizuoka (JP); Hisashi Nakajima, Shizuoka (JP); Saori Yamada, Shizuoka (JP)

(21) Appl. No.: 13/416,451

(22) Filed: Mar. 9, 2012

(30) Foreign Application Priority Data
Mar. 29, 2011 (JP) 2011-072348

(51) Int. Cl. G03G 21/16; G03G 13/20

(52) U.S. Cl. 399/111; 399/321

(57) ABSTRACT

An electrophotographic image forming method, including fixing one or more chromatic toner images on a recording medium; and fixing a transparent toner image on the chromatic toner image to partially or wholly increase glossiness of the recording medium, wherein the chromatic toner image has an average length (Sm) of concavities and convexities of from 50 to 350 μm.

### CROSS-REFERENCE TO RELATED APPLICATIONS

This patent application is based on and claims priority pursuant to 35 U.S.C. §119 to Japanese Patent Application No. 2011-072348, filed on Mar. 29, 2011, in the Japanese Patent Office, the entire disclosure of which is hereby incorporated herein by reference.

### FIELD OF THE INVENTION

The present invention relates to an electrophotographic image forming method and a process cartridge used for electrophotographic processes in copiers, laser printers, facsimiles, etc.

### BACKGROUND OF THE INVENTION

An electrophotographic image forming method used in image forming apparatuses such as laser printers and dry electrostatic copiers includes a process of uniformly charging the surface of an image bearer such as photoconductive layers, a process of irradiating the surface of the image bearer and dissipating a charge of a part irradiated to form an electrostatic latent image, a process of transferring a charged fine powder called toner to the latent image to be visualized, a process of transferring the visualized image onto a recording medium such as transfer papers, a process of eternally fixing the visualized image thereon upon application of heat and pressure, and a process of cleaning the untransferred fine powders remaining on the image bearer.

Recent electrophotographic image formation needs to produce a variety of images. In compliance with a request for photographic imagery, glossiness is applied to the surface of a recording medium such as recording papers to produce clear glossy images. Japanese published unexamined applications Nos. 4-278967, 4-362960 (Japanese Patent No. 3146367) and 9-200551 disclose a method of locating a transparent toner on a non-image part having no chromatic toner to eliminate a difference of glossiness between the non-image part and the chromatic toner part or a method of locating a transparent toner on the whole surface of a recording medium. In addition, an image forming apparatus including an online and compact fixing process system capable of selecting glossy or non-glossy images is available, e.g, Japanese published unexamined application No. 5-158364 discloses a method of heating and melting a recording medium a chromatic toner image and a transparent toner image are formed on with a fixer, and cooling and scraping them to make the whole surface of the recording medium a highly glossy image. The methods disclosed in the above-mentioned applications are capable of providing a uniform glossiness on the whole surface of a recording medium. However, these uniform glossiness on the whole surface of a recording medium, and are not suitable for providing a spot glossiness and have low flexibility of the form of a glossy part formed on a chromatic color image.

Meanwhile, in printing field, as methods of controlling glossiness of a recording medium, UV varnishing, varnishing, PP application process and spot varnishing which makes a specific part have high glossiness (spot glossiness) are typically made. In this case, a print block for forming a partial high glossiness is made after typically color printing, and a spot printing is made on the color printing with a UV varnish. A part the spot varnish is made on has high glossiness like a photo and the other parts the spot varnish is not made on have low glossiness, and a difference of glossiness is large enough to distinguish from typical printing.

However, an exclusive block needs preparing when a spot varnish is made in offset printing, and which is unable to comply with mutable data and need a specific number or more of lots to be printed. The electrophotographic image forming method used in image forming apparatuses such as laser printers and dry electrostatic copiers capable of executing spot printing needs no print block and can comply with mutable data, which is increasingly demanded in the market.

As methods of electrophotographically forming glosses different from each other on a same recording medium, Japanese published unexamined application No. 8-220821 (Japanese Patent No. 2750105) discloses a method of controlling glossiness with a number-average molecular weight of a resin used in a toner, Japanese published unexamined application No. 2009-109926 discloses a method of fixing a color toner, forming a transparent toner image and decreasing a fixing temperature to decrease glossiness, and Japanese published unexamined application No. 4-338984 discloses a method of printing and fixing a glossy range first and printing and fixing a non-glossy range secondly. However, although these methods can obtain different glossiness on the same recording medium, spot high glossiness like photo glossiness by the spot varnishing is not yet obtained.

Japanese Patent No. 3473588 discloses a method of specifying relationships between an average surface roughness Ra and Ra′, and between a maximum surface roughness Rmax and Rmax′, wherein Ra and Rmax are those when a chromatic toner and a transparent toner are formed and Ra′ and Rmax′ are those when only a chromatic toner is formed without a transparent toner, to improve image glossiness and granularity. However, as mentioned later, the present inventors discovered that the average surface roughness Ra and the maximum surface roughness Rmax does not influence upon glossiness of the electrophotographic image surface much, and that an average length Sm of concavities and convexities is most related with the glossiness. Further, Japanese Patent No. 3473588 needs to fix a transparent toner layer on a non-image area and does not have such a high flexibility as that of the spot glossiness partially forming a transparent toner layer on an image to make a contrast difference in glossiness.

Because of these reasons, a need exists for an electrophotographic image forming method of more efficiently producing glossiness and enlarging contrast in glossiness between a part where a transparent toner image is formed and a part where it is not formed.

### SUMMARY OF THE INVENTION

Accordingly, an object of the present invention is to provide an electrophotographic image forming method of more efficiently producing glossiness and enlarging contrast in glossiness between a part where a transparent toner image is formed and a part where it is not formed.

Another object of the present invention is to provide a process cartridge using the image forming method.

The object of the present invention, either individually or collectively, have been satisfied by the discovery of an electrophotographic image forming method, comprising:

fixing one or more chromatic toner images on a recording medium; and

fixing a transparent toner image on the chromatic toner image to partially or wholly increase glossiness of the recording medium,

wherein the chromatic toner image has an average length (Sm) of concavities and convexities of from 50 to 350 μm.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

FIG. 1 is a diagram for explaining a preferred embodiment having a maximum peak at a loss tangent (at from 80 to 160° C.) obtained by viscoelasticity (G′, G″) evaluation;

FIG. 2 is a schematic view illustrating a toner directly fixed on a paper;

FIG. 3 is a schematic view illustrating a transparent toner fixed on a chromatic toner layer does not have a smooth surface, resulting in low glossiness;

FIG. 4 is a schematic view illustrating a transparent toner having a maximum peak value not less than 3 at a loss tangent (tan σ), fixed on a chromatic toner layer, has a smooth surface and high glossiness;

FIG. 5 is a schematic view illustrating an embodiment of electrophotographic image forming apparatus used in the present invention;

FIG. 6 is a schematic view illustrating an embodiment of image developer used in the present invention;

FIG. 7 is a schematic view illustrating an embodiment of image forming apparatus including the image developer in FIG. 6;

FIG. 8 is a schematic view illustrating another embodiment of image forming apparatus used in the present invention; and

FIG. 9 is a schematic view illustrating an embodiment of process cartridge used in the present invention.

### DETAILED DESCRIPTION OF THE INVENTION

The present invention provides an electrophotographic image forming method of more efficiently producing glossiness and enlarging contrast in glossiness between a part where a transparent toner image is formed and a part where it is not formed.

More particularly, the present invention relates to an electrophotographic image forming method, comprising:

fixing one or more chromatic toner images on a recording medium; and

fixing a transparent toner image on the chromatic toner image to partially or wholly increase glossiness of the recording medium,

wherein the chromatic toner image has an average length (Sm) of concavities and convexities of from 50 to 350 μm.

When a transparent toner is used for the purpose of imparting spot glossiness to a chromatic toner image, first of all, a part where a transparent toner image is fixed on needs to have high glossiness.

Not only the transparent toner, the surface smoothness of a toner image, in other words, the surface roughness thereof is an important factor of the glossiness of a toner image.

As Japanese Patent No. 3473588 discloses, plural arts using a relation between the glossiness and the surface roughness of a toner image are disclosed. Particularly, the average surface roughness Ra and the maximum surface roughness Rmax are typical standards of the surface roughness of a material, and they are often used in the arts using a relation between the glossiness and the surface roughness.

The present inventors studied standards of roughness related to the glossiness when thinking of a relation between the glossiness and the roughness of the surface of a toner image. Specifically, samples having various surface roughness were prepared, and the glossiness and the standards of the surface roughness were compared to search a standard thereof largely affecting the glossiness. As a result, the conventional Ra and Rmax have a relation with the glossiness only under limited conditions, e.g., fixing conditions or sample toners are same, and do not have an obvious relation therewith when different images are mixed. They discovered that a parameter of the surface roughness most typically related to the glossiness as a standard is “average length of concavities and convexities Sm”.

In order to improve the glossiness of a toner, the surface of a background a toner is fixed on may be thought to be smoothened.

When a toner image is formed on a paper as a background, the smaller the Ra of the paper, the smoother the surface of a toner image tends to be. Therefore, a paper having a small Ra is effectively used to improve the glossiness of a color toner image.

However, when a transparent toner image is formed for the purpose of obtaining spot glossiness, a transparent toner image is formed on a fixed toner image as a background in many cases. In that case, the smoother the toner image as a background, the surface of the transparent toner formed on the toner image does not necessarily become smoother and the glossiness does not necessarily increase.

When a transparent toner image is overlapped on one or more chromatic toner images formed on a recording medium (when there is a transparent toner image forming process after a chromatic toner image forming process), it is not an average surface roughness Ra but an average length of concavities and convexities that most contributes the glossiness of the transparent toner image. Further, when the surface of the under layer, i.e., the chromatic toner image has a Sm not less than 50 μm, the larger the Sm (smoother), the lower the glossiness of the transparent toner image. Namely, in order to improve the glossiness of the transparent toner image, the smaller (rougher), the better the Sm (surface) of the chromatic toner image when less than 50 μm.

This is thought to be a specific phenomenon when a toner is further fixed on a fixed toner image like spot glossiness application with a transparent toner.

A particulate toner is plastically deformed to planar toner layer because of being heated and presses. However, when a storage elastic modulus (G′) is higher than a loss elastic modulus (G″) of a toner, the shape of the particulate toner returns and remains as it is to some extent even after fixed. The particulate toner appearing on the surface of the fixed image are microscopic concavity and convexity, and the surface thereof is roughened and good glossiness is difficult to obtain.

However, when a fixed image is directly formed on a paper, since woven cellulose fibers of the paper have plasticity and a gap therebetween absorbs the remaining particulate toner, the remaining particulate toner after fixed is difficult to appear on the surface of the fixed image (FIG. 2). However, like spot glossiness application with a transparent toner, when a background is a (chromatic) color toner layer, the background toner layer is difficult to absorb a particulate shape of an upper transparent toner layer (FIG. 3).

Then, the smoother the surface of the background toner layer, the particulate shape of the transparent toner is easy to appear on the surface of the final image. On the contrary, when the surface of the background toner layer has roughness to some extent, since a groove of the roughness absorbs the particulate shape of the transparent toner and it is difficult to appear on the surface of an image, the final image has high glossiness.

FIG. 2 is a schematic view illustrating a toner directly fixed on a paper. In FIG. 2, numeral 1 is a paper, 2 is a cellulose fiber and 3 is a toner layer. FIG. 3 is a schematic view illustrating a transparent toner fixed on a chromatic toner layer does not have a smooth surface, resulting in low glossiness. In FIG. 3, numeral 1 is a paper, 2 is a cellulose fiber, 4 is a chromatic toner layer and 5 is a transparent toner layer.

In the present invention, the surface of the background chromatic toner image has roughness to some extent and an average length Sm of its convexities and concavities is 350 μm or less. When larger than 350 μm, the surface of the background toner later is too smooth and the particulate shape of the transparent toner is easy to appear, resulting in poor glossiness.

In addition, Sm is 50 μm or more as well in the present invention. When less than 50 μm, the background is so rough that the surface of the transparent toner image is rough as well, resulting in poor glossiness.

In the present invention, Sm and Ra are measured by SURFCOM 590a from TOKYO SEIMITSU CO., LTD.

In order to make the spot glossiness of the transparent toner look better, a difference (contrast) of glossiness between a part where a transparent toner image is formed and the other part where a transparent toner image is not formed is preferably large. Therefore, it is essential that the transparent toner image has higher glossiness, but it is effective as well to lower the glossiness of the background image which is not applied with glossiness. In the present invention, the background chromatic toner image which is not applied with glossiness has an Sm of 250 μm or less to lower the glossiness thereof. The contrast of glossiness with the transparent toner image is good and the spot glossiness looks much better.

Methods of roughening the surface of the chromatic toner image which is a background of the transparent toner image include, but are not limited to, a method of lowering a fixing temperature to leave a particulate shape of the background chromatic toner image, a method of using a recoding medium such as a paper having a rough surface (a large Ra) on which the background chromatic toner image is fixed as mentioned above and a method of thinning the thickness of a fixed image toner layer such that the particulate shape noticeably appears on the surface of the chromatic toner image.

The transparent toner preferably has a loss tangent determined by the following formula (1), having a maxim peak not less than 3 at from 80 to 160° C.

Loss elastic modulus (G″)/Storage elastic modulus (G′)=Loss tangent (tan δ) (1)

The transparent toner needs to quickly have a low storage elasticity at low temperature to fix at low temperature and have high glossiness. When the storage elastic modulus (G′) is low in fixing, a melted toner is easy to enter a recording paper having a low surface smoothness or microscopic concavities and convexities of the chromatic toner. In addition, a plasticizer component relatively increases in viscoelasticity and it is difficult to restore the shape of a particulate toner. Therefore, the transparent toner has good extendability, high surface smoothness and high glossiness.

Meanwhile, in terms of hot offset resistance, the storage elastic modulus (G′) gradually lowers from a viscosity and it is important o maintain the viscosity. Further, it is necessary for the loss elastic modulus (G″) not to lower so quickly as the storage elastic modulus (G′).

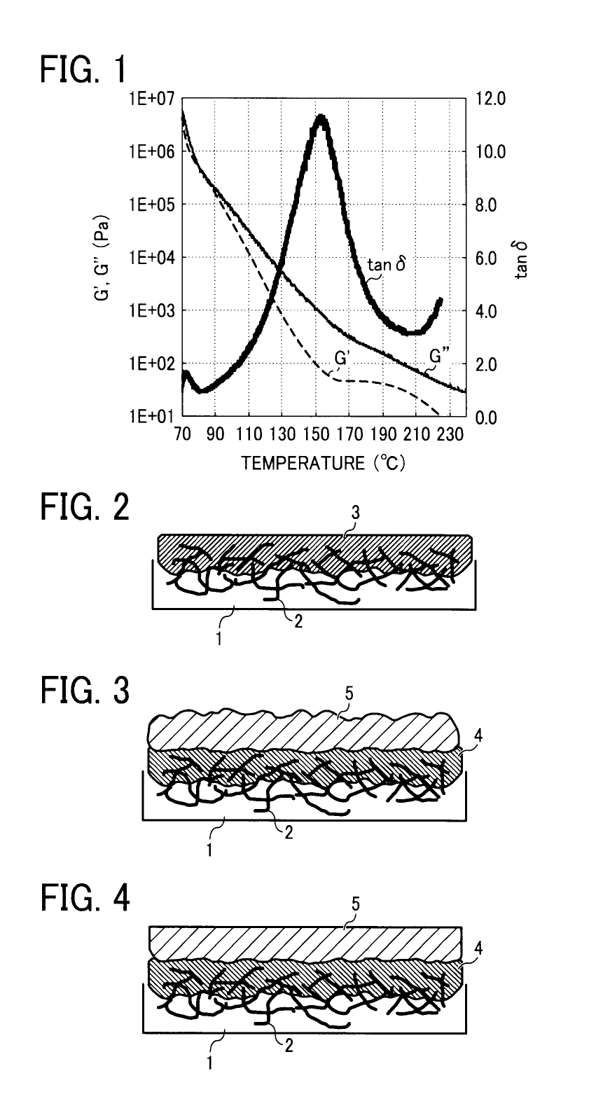

Unless the storage elastic modulus (G′) quickly lowers from a temperature and gradually lowers from a temperature, the loss tangent peak in FIG. 1 does not appear.

Only such a toner has loss tangent having a maximum peak of, and preferably at from 80 to 160° C. in terms of storage of the toner and low-temperature fixability thereof.

When less than 80° C., the storage elastic modulus (G′) of the toner deteriorates, resulting in poor storage stability thereof and aggregation thereof in a storage environment. Further, the toner has too low viscoelasticity, resulting in poor hot offset resistance. When higher than 160° C., the toner deteriorates in low-temperature fixability.

When a maximum value of the loss tangent is small, the storage elastic modulus (G′) is not lower than the loss elastic modulus (G″), the toner does not have preferred low-temperature fixability, hot offset resistance and glossiness. Particularly, the loss tangent of a transparent toner is preferably not less than 3 to impart glossiness to a recording medium therewith.

As mentioned above, in order to increase glossiness of the transparent toner image, the surface hereof is preferably smooth and the particulate shape thereof after fixed preferably does not remain.

When the storage elastic modulus (G′) has a ratio higher than that of the loss elastic modulus (G″), the particulate shape of the transparent toner tends to remain because of “return” due to elasticity of the transparent toner itself even when fixed with pressure. Further, the surface of the transparent toner has microscopic waves, deteriorates in smoothness, and is difficult to have glossiness.

However, when a transparent toner has a loss tangent (tan δ) having a maximum peak of 3 or more in a fixable temperature, the transparent toner has a smooth surface because its extendability is larger than its elasticity and efficiently has glossiness while maintaining hot offset resistance (FIG. 4).

An upper limit of the loss tangent is not particularly limited, but hot offset resistance of the toner tends to deteriorate and a production apparatus is easy to contaminate in producing the toner when too high. Therefore, the loss tangent is preferably 50 or less, and more preferably 30 or less.

The maximum peak temperature and the maximum peak value of the loss tangent (tan δ) are almost determined by a viscoelasticity of a resin, but they can be changed by a load to the resin in producing a toner, such as melting and kneading conditions.

Further, even when using a crystalline polyester mentioned later together, since a softening point or a content thereof in a toner changes the viscoelasticity of the toner, the maximum peak temperature and the maximum peak value of the loss tangent (tan δ) can be changed.

FIG. 4 is a schematic view illustrating a transparent toner having a maximum peak value not less than 3 at a loss tangent (tan δ), fixed on a chromatic toner layer, has a smooth surface and high glossiness. In FIG. 4, numeral 1 is a paper, 2 is a cellulose fiber, 4 is a chromatic toner layer and 5 is a transparent toner layer.

In the present invention, the storage elastic modulus (G′) is preferably from 1 to 1×10⁴ Pa at from 120 to 160° C., and more preferably from 1 to 1×10⁴ Pa at from 110 to 160° C. Even when the loss tangent is large, the toner does not have a preferred low-temperature fixability when the storage elastic modulus (G′) is larger than to 1×10⁴ Pa at from 120 to 160° C. When less than 1 Pa, the toner deteriorates in hot offset resistance. When the storage elastic modulus (G′) is 1 to 1×10⁴ Pa at from 110 to 160° C., the toner has more preferred low-temperature fixability. The storage elastic modulus (G′) is preferably not less than 1×10⁵ Pa, and more preferably from 1 to 1×10⁶ Pa at from 70 to 90° C.

In an environment of temperature not higher than a fixable temperature, a toner and a developer including the toner deteriorates in storage stability when having a low storage elastic modulus (G′). Particularly, the storage elastic modulus (G′) at 90° C. or less noticeably influences upon the storage stability, and when less than 1×10⁵ Pa at 90° C. or less, the toner tends to agglutinate or be solidified when stored. A lower limit of temperatures at which the storage elastic modulus (G′) to be not less than 1×10⁵ Pa is not higher than a lower limit of temperatures assumed to be a storage environment of the toner. Typically, when a thermoplastic resin is used as a toner material, the storage elastic modulus (G′) tends to increase when the temperature lowers to a temperature not higher than 70 to 90° C. Therefore, a toner having the storage elastic modulus (G′) not less than 1×10⁵ Pa at from 70 to 90° C. can maintain storage stability under a living environment.

The storage elastic modulus (G′) at from 90 to 120° C. is not particularly specified. As mentioned above, a toner having a storage elastic modulus (G′) not less than 1×10⁵ Pa at from 70 to 90° C. and 1×10⁴ Pa at from 120 to 160° C. has a storage elastic modulus (G′) of from 1×10⁴ to 1×10⁵ Pa at from 90 to 120° C., which preferably does not have an unexpected peak relative to a temperature and gently changes

The loss tangent (tan δ) is measured by viscoelasticity measurement.

In the present invention, 0.8 g of a toner is formed with a dice having a diameter of φ20 mm at a pressure of 30 MPa. The loss elastic modulus (G″), the storage elastic modulus (G′) and the loss tangent (tan δ) were measured by ADVANCED RHEOMETRIC EXPANSION SYSTEM from TA Instruments using a parallel corn having a diameter of 20 mm under the following conditions.

Frequency: 1.0 Hz

Rate of temperature increase: 2.0° C./min

Distortion (automatic distortion control): 0.1%

Allowable minimum stress: 1.0 g/cm

Allowable maximum stress: 500 g/cm

Maximum load distortion: 200%

Distortion adjustment: 200%

The loss tangent (tan δ) value when the storage elastic modulus (G′) is 10 or less is excluded.

The transparent toner in the present invention preferably includes a crystalline polyester resin and a lubricant, can include other conventionally-known materials such as a binder resin and a charge control agent, and further an external additive may adhere to the surface of a mother toner formed of these materials.

The chromatic toner in the present invention preferably includes a crystalline polyester resin and a colorant, can include other conventionally-known materials such as a binder resin and a charge control agent, and further an external additive may adhere to the surface of a mother toner formed of these materials.

The transparent toner in the present invention preferably includes a crystalline polyester resin as a thermoplastic resin. A combination of the crystalline polyester resin enables a toner to fix at lower temperature and further increase glossiness of the resultant images even at low temperature. The transparent preferably includes the crystalline polyester resin in an amount of from 1 to 25 parts by weight, and more preferably from 1 to 15 parts by weight per 100 parts by weight of a binder resin (e.g., a noncrystalline polyester resin). When the transparent toner includes the crystalline polyester resin too much, filming of the toner over the surface of an image bearer such as photoreceptors tends to occur and storage stability thereof deteriorates, and further the transparency deteriorates.

The crystalline polyester resin used in the present invention is prepared by, e.g., conventionally polycondensating (1) a polycarboxylic acid unit formed of a direct-chain unsaturated aliphatic dicarboxylic acid or its reactive derivative such as acid anhydrides and lower alkyl ester acid halides having 1 to 4 carbon atoms and (2) a polyol unit formed of a direct-chain aliphatic diol. The polycarboxylic acid unit may include a small amount of another polycarboxylic acid unit when necessary. The direct-chain unsaturated aliphatic dicarboxylic acid unit as the polycarboxylic acid unit can more easily form a crystalline structure of the crystalline polyester resin than an aromatic dicarboxylic acid unit.

The polycarboxylic acid unit includes (a) an unsaturated aliphatic dicarboxylic acid unit having a branched chain, (b) a saturated aliphatic polycarboxylic acid unit such as a saturated aliphatic dicarboxylic acid and a saturated aliphatic tricarboxylic acid and (c) an aromatic polycarboxylic acid unit such as an aromatic dicarboxylic acid and an aromatic tricarboxylic acid, etc. The crystalline polyester typically includes the polycarboxylic acid unit in an amount not greater than 30% mol, and preferably not greater than 10% mol, and properly included as far as the polyester has crystallinity.

Specific examples of the carboxylic acids addable when necessary include dicarboxylic acids such as a malonic acid, a succinic acid, a glutaric acid, an adipic acid, a suberic acid, a sebacic acid, a citraconic acid, a phthalic acid, an isophthalic acid and a terephthalic acid; and tri- or more polycarboxylic acid units such as a trimellitic acid anhydride, 1,2,4-benzenetricarboxylic acid, 1,2,5-benzenetricarboxylic acid, 1,2,4-cyclohexanetricarboxylic acid, 1,2,4-naphthalanetricarboxylic acid, 1,2,5-hexanetricarboxylic acid, 1,3-dicarboxyl-2-methylenecarboxypropane and 1,2,7,8-octantetracarboxylic acid.

The crystalline polyester resin may include a small amount of an aliphatic branched chain diol unit, a cyclic diol unit or a tri- or more polyol unit when necessary as far as the polyester has crystallinity. Specific examples of the polyol unit addable when necessary include a 1,4-bis(hydroxymethyl)cyclohexane unit, a polyethyleneglycol unit, an ethyleneoxide adduct of bisphenol A unit, a propyleneoxide adduct of bisphenol A unit, a glycerin unit, etc.

The crystalline polyester resin preferably has a sharp molecular weight distribution in terms of low-temperature fixability and comparatively a low molecular weight. The crystalline polyester resin preferably has, but not limited to, a softening point of from 60 to 120° C. when measured by elevated flow tester CFT-100D from Shimadzu Corp.

The transparent toner in the present invention preferably include a lubricant. The transparent toner needs to have high hot offset resistance because of being located on the top of an image. However, as mentioned above, when the loss tangent (tan δ) is high, the storage elastic modulus is comparatively low and risk of hot offset occurrence increases. Therefore, a lubricant is preferably included in the transparent toner as well to increase releasability thereof from a fixer and reduce the risk of hot offset occurrence.

Specific examples of the lubricant include, but are not limited to, an aliphatic hydrocarbon lubricants such as a fluid paraffin, a microcrystalline wax, a natural paraffin, a synthesized paraffin, a polyolefin wax, and their partial oxides, fluorides or chlorides; animal waxes such as a beef fat and a fish oil; plant oils such as a coconut oil, a soy oil, a canola oil, a rice bran wax, a carnauba wax; higher aliphatic alcohols or higher aliphatic lubricants such as a montan wax; metallic soap lubricants such as an aliphatic amide, an aliphatic bisamide, a zinc stearate, a calcium stearate, a magnesium stearate, an alumina stearate, a zinc oleate, a zinc palmitate, a magnesium palmitate, a zinc myristate, a zinc laurate and a zinc behenate; aliphatic ester lubricants; polyvinylidene fluorides, etc.

Among these lubricants, the aliphatic amide lubricants are preferably used.

The lubricant can be used alone or in combination. The toner preferably includes the lubricant in an amount of from 0.1 to 15 parts by weight, and more preferably from 1 to 7 parts by weight per 100 parts by weight of a binder resin. The toner including the lubricant has good hot offset resistance, fixing strength and friction resistance. When used in a high-speed image forming apparatus, the toner has good low-temperature fixability. When less than 0.1 parts by weight, offset tends to occur. When greater than 15 parts by weight, carrier spent tends to occur and the resultant images tends to deteriorate. When the lubricant is included in the surface layer of the toner, it is preferably included in an amount of from 0.001 to 1 parts by weight, and more preferably from 0.01 to 0.3 parts by weight per 100 parts by weight of the binder resin.

Including the lubricant in the toner means a mother toner includes the lubricant and the lubricant is not externally added thereto. Namely, the lubricant may be included in a capsule which is not exposed on the surface of the mother toner, or uniformly or properly dispersed therein and partially exposed on the surface thereof.

Including the lubricant in the surface layer of the toner means the lubricant adheres to the surface of the mother toner.

The aliphatic amide lubricant included in the toner accelerates crystallization of the crystalline polyester in addition to lubricity to improve storage stability of the toner. The aliphatic amide lubricant may be used alone, or combined with a lubricant besides the aliphatic amide lubricant to separately control functions of releasability and acceleration of crystallizing the crystalline polyester, such as carnauba wax, paraffin waxes and aliphatic amide waxes effectively used to enhance releasability. Specific examples of the aliphatic amide waxes include stearic acid amide, oleic acid amide, erucamide, ethylene-bis stearic acid amide, etc. Particularly, N,N′-ethylene-bis stearic acid amide is preferably used.

Any known binder resins can be used in the transparent toner and the chromatic toner in the present invention. Specific examples of the resins include styrene resins such as styrene, poly-α-methylstyrene, styrene-chlorostyrene copolymers, styrene-butadiene copolymers, styrene-vinylchloride copolymers, styrene-vinylacetate copolymers, styrene-maleic acid copolymers, styrene-ester acrylate copolymers, styrene-α-methylchloroacrylate copolymers and styrene-acrylonitrile-ester acrylate copolymers (polymers or copolymers including styrene or styrene substituents); polyester resins; epoxy resins; vinylchloride resins; rosin-modified maleic acid resins; phenol resins; polyethylene resins; polypropylene resins; petroleum resins; polyurethane resins; ketone resins; ethylene-ethylacrylate copolymers, xylene resins; and polyvinylbutyral resins. Methods of preparing these resins are not particularly limited, and any of bulk polymerization methods, solution polymerization methods, emulsion polymerization methods and suspension polymerization methods can be used.

Polyester resins are preferably used as the binder resin, particularly as a main component therein in the present invention. The polyester resin typically has more low-temperature fixability than other resins while having thermostable storage stability.

The polyester resin used in the present invention can be obtained from a condensed polymerization between alcohol and a carboxylic acid. Specific examples of the alcohol include glycols such as ethyleneglycol, diethyleneglycol, triethyleneglycol and propyleneglycol; etherified bisphenol such as 1,4-bis(hydroxymethyl)cyclohexane and bisphenol A; a diol monomer; and a tri- or more polyol monomer.

Specific examples of the carboxylic acids include units obtained from a dihydric organic-acid monomer such as maleic acid, fumaric acid, phthalic acid, isophthalic acid, terephthalic acid, succinic acid and malonic acid; and units obtained from a tri-or-more hydric carboxylic-acid monomer such as 1,2,4-benzenetricarboxylic acid, 1,2,5-benzenetricarboxylic acid, 1,2,4-cyclohexanetricarboxylic acid, 1,2,4-naphthalanetricarboxylic acid, 1,2,5-hexanetricarboxylic acid, 1,3-dicarboxyl-2-methylenecarboxypropane and 1,2,7,8-octantetracarboxylic acid. The polyester resin preferably has a glass transition temperature Tg of from 50 to 75° C.

Methods of preparing the transparent toner in the present invention are not particularly limited, and it may be prepared by any methods such as a pulverization method, an emulsion polymerization method, a suspension polymerization method and a polyester elongation method. Particularly, since a lubricant is present on the surface which is a crack interface of a transparent toner prepared by the pulverization method at high possibility, the lubricant directly contacts an image bearer and a thin film of the lubricant is easy to form on the surface thereof, which makes it easy to separate the transparent toner from the image bearer and prevents the transparent toner from adhering thereto again.

The transparent toner image has higher glossiness when the toner layer is thicker. This is because the shape of the particulate transparent toner is absorbed in a width of the toner layer and does not appear on the surface. The transparent toner layer preferably has a thickness of from 1 to 15 μm. When less than 1 μm, the transparent toner image is difficult to have higher glossiness. When greater than 15 μm, the transparent toner is not fully deformed by heat and the shape of the particulate transparent toner tends to remain, resulting in poor glossiness. In addition, the transparent toner is not firmly fixed and has poor transparency, resulting in deterioration of color reproducibility of the background toner image. The thickness of the toner layer is measured by cutting a recording medium on which a toner image is formed by a microtome.

Specific examples of colorants included in the chromatic toner used in the present invention include any known dyes and pigments such as carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials are used alone or in combination. The toner particles preferably include the colorant in an amount of from 1 to 15% by weight, and more preferably from 3 to 10% by weight.

The colorant may be used as a masterbatch pigment combined with a resin. Specific examples of the resin include the binder resins mentioned above.

The transparent toner and the chromatic toner in the present invention may include a charge controlling agent.

Specific examples thereof include, but are not limited to, Nigrosine and its modified material, metal salts of fatty acids and their modified materials, onium salts such as phosphonium salts and their lake pigments, triphenylmethane dyes and their lake pigments, metal salts of higher fatty acids; diorganotinoxides such as dibutyltinoxide, dioctyltinoxide and dicyclohexyltinoxide; diorganotinborates such as dibutyltinborate, dioctyltinborate and dicyclohexyltinborate; organic metal complexes, chelate compounds, monoazo metal complexes, acetylacetone metal complexes, aromatic hydroxycarboxylic acids, metal complexes of aromatic dicarboxylic acids and quaternary ammonium salts. In addition, aromatic mono and polycarboxylic acids and their metal salts, anhydrides, esters and phenol derivatives such as bisphenol can be used. These can be used alone or in combination.

The toner preferably includes the charge controlling agent in an amount of from 0.1 to 10 μarts by weight per 100 parts of the binder resin. The transparent toner preferably includes the white or transparent charge controlling agent because of being used as a colorant occasionally.

Further, the transparent and chromatic toners may include an external additive.

Specific examples thereof include abrasives such as silica, TEFLON (registered trademark) resin powder, polyvinylidene fluoride powder, cerium oxide powder, silicon carbide powder and strontium titanate powder; fluidity improvers such as titanium oxide powder and aluminum oxide powder; aggregation inhibitor; resin powder; and conductivity imparting agent such as zinc oxide powder, antimony oxide powder and tin oxide powder. In addition, white particulate materials and black particulate materials can be used as developability improvers. These can be used alone or in combination, and can protect the toner from stress when stirred.

The transparent toner in the present invention preferably has a weight-average particle diameter of from 3 to 8 μm, a ratio of particles having a particle diameter not greater than 4 μm of from 10 to 70% by number, a ratio of particles having a particle diameter not less than 8 μm of from 1 to 20% by volume, and a ratio of particles having a particle diameter not less than 10.08 μm not greater than 6% by volume.

When the weight-average particle diameter is greater than 8 μm, the toner scatters more from an image developer to contaminate the inner of the apparatus and abnormal images such as background fouling are produced on recording media. When less than 3 μm, a particle is relatively heated more and the toner noticeably sticks to the surface of a fixing roller, resulting in deterioration of image quality. Methods of preparing the toner in the present invention are not particularly limited, and it may be prepared by any methods such as a pulverization method, an emulsion polymerization method, a suspension polymerization method and a polyester elongation method. However, the pulverization method is very difficult to pulverize and classify particles having a weight-average particle diameter less than 3 μm, and industrial productivity of a yield rate of the toner deteriorate.

The glossiness is most desired for the transparent toner. The toner needs to have good heat meltability to have high glossiness, but thermostable storage stability thereof possibly deteriorates as an adverse effect. Namely, the toner tends to have an aggregate.

The transparent toner in the present invention, having a weight-average particle diameter of from 3 to 8 μm and a ratio of particles having a particle diameter not greater than 4 μm of from 10 to 70% by number can produce high definition transparent toner image while preventing the aggregate. When the ratio of particles having a particle diameter not greater than 4 μm is less than 10% by number, a high definition transparent toner image is difficult to produce.

When the transparent toner has a ratio of particles having a particle diameter not less than 8 μm of from 1 to 20% by volume, a particle thereof covers a larger area of a recording medium and the resultant toner image has higher smoothness and glossiness. This effect is more efficiently exerted particularly when the loss tangent has a maximum peak not less than 3. This effect is difficult to exert when a ratio of particles having a particle diameter not less than 8 μm is less than 1% by volume. When greater than 20% by volume, the surface of the transparent toner image harshens, loses smoothness and deteriorates in glossiness.

When the transparent toner has a ratio of particles having a particle diameter not less than 10.08 μm greater than 6% by volume, the transparent toner image harshens and loses smoothness rather than improvement of smoothness because of larger coverage of a particle of the toner, resulting in deterioration of glossiness. Further, a high-definition transparent toner image is difficult to produce.

The volume-average particle diameter and the number-average diameter are measured Coulter Counter TA-II and Coulter Multisizer II, III and IV from Coulter Electronics, Inc. under the following method.

0.1 to 5 ml of a detergent, preferably alkylbenzene sulfonate is included as a dispersant in 100 to 150 ml of the electrolyte ISOTON-II from Coulter Scientific Japan, Ltd., which is a NaCl aqueous solution including an elemental sodium content of 1%;

2 to 20 mg of a toner sample is included in the electrolyte to be suspended therein, and the suspended toner is dispersed by an ultrasonic disperser for about 1 to 3 min to prepare a sample dispersion liquid; and

a volume and a number of the toner particles for each of the following channels are measured by the above-mentioned measurer using an aperture of 100 μm to determine a volume distribution and a number distribution:

2.00 to 2.52 μm; 2.52 to 3.17 μm; 3.17 to 4.00 μm; 4.00 to 5.04 μm; 5.04 to 6.35 μm; 6.35 to 8.00 μm; 8.00 to 10.08 μm; 10.08 to 12.70 μm; 12.70 to 16.00 μm; 16.00 to 20.20 μm; 20.20 to 25.40 μm; 25.40 to 32.00 μm; and 32.00 to 40.30 μm.

The volume-average particle diameter and the number-average diameter of a toner can be determined from the distributions.

The electrophotographic image forming method of the present invention can use both of one-component and two-component developing methods.

When a two-component developing method is used, magnetic particulate materials used as a magnetic carrier include magnetite, spinel ferrites such as gamma iron oxide, spinel ferrites including one or more metals except for iron such as Mn, Ni, Zn, Mg and Cu, magnetoplumbite ferrites such as barium ferrite, and particulate iron or alloy having an oxidized surface layer. The magnetic particulate material may have a granular, spherical or acicular form. Particularly, ferromagnetic particulate materials such as iron is preferably used when high magnetization is required. In consideration of chemical stability, magnetite, spinel ferrites including gamma iron oxide and magnetoplumbite ferrites such as barium ferrite are preferably used.

Specific preferred examples include MFL-35S (from POWDERTECH CO., LTD.), MFL-35HS (from POWDERTECH CO., LTD.), DFC-400M (from DOWA IRON POWDER CO., LTD.), etc.

A resin carrier having a desired magnetization can be used by selecting the ferromagnetic particulate materials and the content thereof. The carrier preferably has a magnetization of from 30 to 150 emu/g at 1,000 Oe. The resin carrier is formed by spraying a melted and kneaded material including a magnetic particulate material and an insulative binder resin. Alternatively, a monomer or a prepolymer is reacted and cross-linked in an aqueous medium under the presence of a magnetic particulate material to form a resin carrier in which the magnetic particulate material is dispersed in a condensed binder.

A positively or negatively chargeable particulate material or an electroconductive particulate material is anchored, or a resin is coated on the surface of the magnetic carrier to control its chargeability.

The magnetic carrier is coated with a silicone resin, an acrylic resin, an epoxy resin, a fluorine-containing resin, etc., and further coated with the positively or negatively chargeable particulate material or an electroconductive particulate material. The silicone resin and the acrylic resin are preferably used.

In the present invention, a developer contained in an image developer preferably includes the carrier in an amount not less than 85% and less than 98% by weight. When less than 85% by weight, a toner tends to scatter from the image developer, resulting in production of defective images. When not less than 98% by weight, the toner is overcharged or is not fed enough, resulting in production of defective images having low image density.

As mentioned above, methods of preparing the transparent toner and the chromatic toner in the present invention are not particularly limited, and are prepared by, e.g., mixing a binder resin and a lubricant, and optionally a colorant, a charge controlling agent and an additive by a mixer such as HENSCHEL MIXER and SUPER MIXER to prepare a mixture, melting and kneading the mixture upon application of heat by a heat melting kneader such as a heat roll and an extruder to prepare a kneaded mixture; cooling the kneaded mixture to be solidified to prepare a solid mixture; pulverizing the solid mixture to prepare a pulverized mixture; and classifying the pulverized mixture. The pulverization methods include a jet mill method including a toner in a high-speed stream and crashing the toner into a collision plate; an inter-particles collision method crashing the toners each other in a stream; and a mechanical pulverization method feeding a toner into a narrow gap between rotors rotating at high speed.

The toner can also be prepared by solution suspension methods dissolving or dispersing toner constituents in an organic solvent to prepare an oil phase, dispersing the oil phase in an aqueous medium, de-solventing, filtering, washing and drying. Further, polyester elongation methods can also prepare a mother toner.

The electrophotographic image forming method of the present invention is characterized by having a process of fixing one or more chromatic toner images on a recording medium; and a process of fixing a transparent toner image on the chromatic toner image to partially or wholly increase glossiness of the recording medium, in which the chromatic toner image has an average length (Sm) of concavities and convexities of from 50 to 350 μm.

The chromatic toner image forming process and the transparent toner image forming process can be made by known electrophotographic image forming methods including a charging process uniformly charging an image bearer, an electrostatic latent image forming process irradiating the charged image bearer to form an electrostatic latent image, a developing process developing the electrostatic latent image with a developer including a toner to form a toner image on a recording medium and a fixing process fixing the toner image on the recording medium. Besides, a cleaning process, a discharge process, etc. may be included.

Namely, a transparent toner image formed by the transparent toner image forming process is layered on a chromatic toner image formed by the chromatic toner image forming process.

Hereinafter, details of the image forming process are explained, referring to drawings.

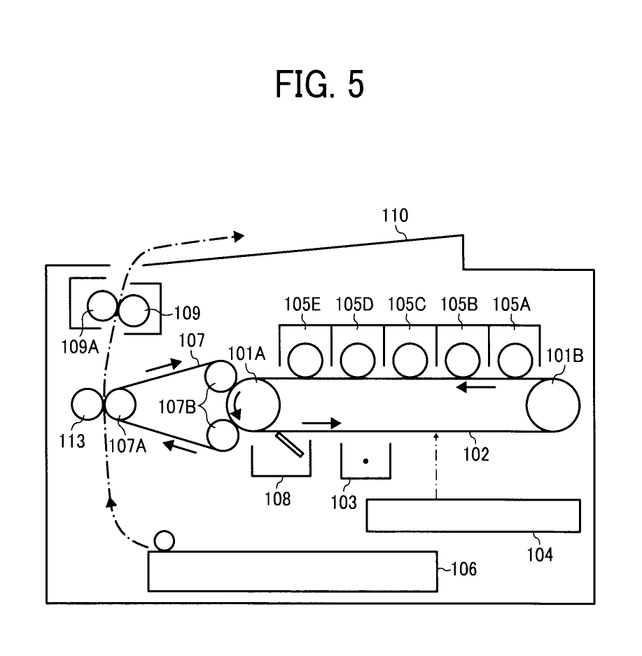

FIG. 5 is a schematic view illustrating an embodiment of electrophotographic image forming apparatus used in the present invention.

In FIG. 5, numeral 101A is a drive roller, 101B is s driven roller, 102 is a photoreceptor belt, 103 is a charger, 104 is a writing unit, 105A to 105D are developing units containing yellow, magenta, cyan and black toners, respectively, 105E is a developing unit containing a transparent toner, 106 is a paper feed cassette, 107 is an intermediate transfer belt, 107A is a drive shaft roller for driving the intermediate transfer belt, 107B is a driven shaft roller supporting the intermediate transfer belt, 108 is a cleaner, 109 is a fixing roller, 109A is a pressure roller, 110 is a discharged paper tray and 113 is a paper transfer roller.

In the color image forming apparatus in FIG. 5, a flexible intermediate transfer belt 107 is used against the transfer drum. The intermediate transfer belt 107 as an intermediate transferer is suspended by a drive shaft roller 107A and a pair of driven shaft rollers 107B with extension, and cyclically transferred clockwise. The belt surface between the pair of driven shaft rollers 107B is contacted to the photoreceptor belt 102 on an outer circumference of the drive roller 101A in a horizontal direction.

Typically, each chromatic toner image formed on the photoreceptor belt 102 is transferred onto the intermediate transfer belt 107 every time when formed to synthesize a full-color toner image. The full-color toner image is transferred onto a transfer paper fed from the paper feed cassette 106 at a time by the paper transfer roller 113. The transfer paper after the full-color toner image is transferred onto is fed between the fixing roller 109 and the pressure roller 109A of the fixer, and discharged onto the discharged paper tray 110.

When each of the developing units 105A to 105E develops a latent image, a toner concentration in a developer contained in the developing unit decreases. An unillustrated toner concentration sensor detects the decrease of the toner concentration in the developer. When the decrease of the toner concentration is detected, an unillustrated toner feeder connected to each of the developing units feeds a toner thereto to increase the toner concentration. A developer including a carrier and a toner for a so-called trickle developing method may be fed if the developing unit is equipped with a developer discharger.

In FIG. 5, toner images are overlapped on an intermediate transfer belt, but the electrophotographic image forming method of the present invention can be used as well even in a system in which a toner image is directly transferred onto a recording medium from a transfer drum without using an intermediate transfer belt.

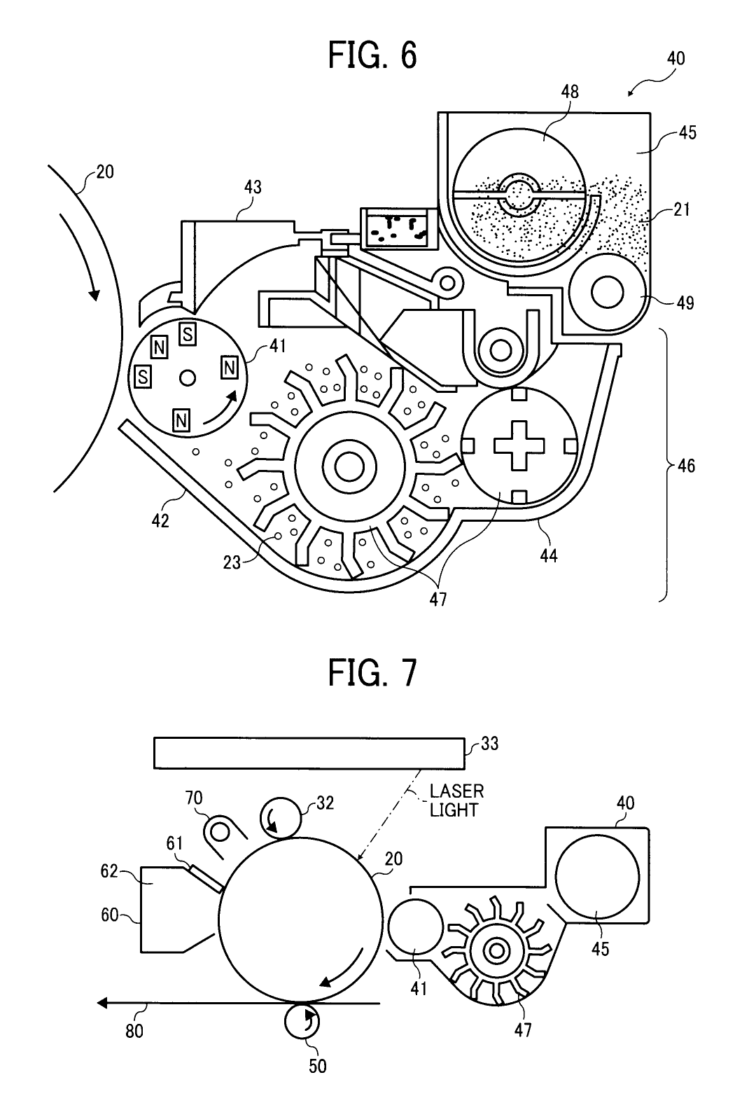

FIG. 6 is a schematic view illustrating an embodiment of image developer used in the present invention, and a modified embodiment mentioned later is included as well in the present invention.

In FIG. 6, an image developer 40 located facing a photoreceptor drum 20 as a latent image bearer is mainly formed of a developing sleeve 41 as a developer bearer, a developer containing member 42, a doctor blade 43 as a regulation member, a support case 44, etc. Hereinafter, the photoreceptor drum 20 is simply called a photoreceptor 20 as well.

The support case 44 having an opening in a direction of the photoreceptor 20 is combined with a toner hopper 45 as a toner container containing a toner 21. A developer container 46 containing a developer formed of the toner 21 and a carrier 23, which is adjacent to the toner hopper 45, is equipped with a developer stirrer 47 stirring the toner and carrier and imparting a friction/separation charge to the toner 21.

The toner hoper 45 includes a toner agitator 48 rotated by an unillustrated driver and a toner feeder 49. The toner agitator 48 and toner feeder 49 feeds the toner 21 in the toner hopper 45 toward the developer container 46 while agitating the toner 21.

The developing sleeve 41 is located in a space between the photoreceptor 20 and the toner hopper 45. The developing sleeve 41 rotated by an unillustrated driver in an arrow direction (anticlockwise) includes a magnet as a magnetic field generator, which is fixedly located in a relative position to the image developer 40, to form a magnetic brush with the carrier 23.

The doctor blade 43 is fitted to an opposite side of the support case 44 in a body to a side thereof the developer containing member 42 is fitted to. The doctor blade 43 is located so as to keep a regular clearance between an end thereof and an outer circumferential surface of the developing sleeve 41 in this embodiment.

The toner 21 fed by the toner agitator 48 and toner feeder 49 from the toner hopper 45 is transported to the developer container 46, where the developer stirrer 47 stirs the toner to impart a desired friction/separation charge thereto. Then, the toner 21 is borne by the developing sleeve 41 with the carrier 23 as a developer and transported to a position facing an outer circumferential surface of the photoreceptor 20, where the toner 21 is electrostatically bonded with an electrostatic latent image formed on the photoreceptor 20 to form a toner image thereon.

FIG. 7 is a schematic view illustrating an embodiment of image forming apparatus including the image developer in FIG. 6.

In FIG. 7, an image bearer charging member [charging member: charger] 32, an imagewise irradiating system [irradiator] 33, a developing device [image developer] 40, a transfer mechanism [transfer device: transferer] 50, a cleaning mechanism [cleaning device: a cleaner] 60 and a discharge lamp [discharger] 70 are located around the drum-shaped photoreceptor [photoreceptor drum: image bearer] 20. In this embodiment, the surface of the charging member 32 does not contact the surface of the photoreceptor drum 20 with a gap of about 0.2 mm therebetween. The charging member 32 is applied with a DC bias overlapped with an AC bias by an unillustrated bias applicator to evenly and effectively charge the photoreceptor drum 20. The image formation including development is made as follows.

A series of image forming processes can be explained with nega-posi processes. The photoreceptor 20 typified by an organic photoconductor having an organic photoconductive layer is discharged by the discharge lamp 70 [discharge process], uniformly and negatively charged by the charging member 32 such as a charger and a charging roller [charging process], and irradiated with a laser beam by the imagewise irradiating system 33 such as a laser optical system to form a latent image (in this embodiment, an absolute value of potential at irradiated part is lower than that at unirradiated part [irradiation process]).

A laser beam emitted from a laser diode is deflected by a polygonal polygon mirror, etc. rotating at a high speed, and scans the surface of the photoreceptor 20 in a rotational direction thereof. The thus formed latent image is developed with a developer including a toner and a carrier fed on the developing sleeve 41 as a developer bearer in of the image developer 40 to form a toner image [developing process]. When a latent image is developed, a bias applicator applies a DC bias overlapped with an AC bias to the developing sleeve 41 between the irradiated part and unirradiated part of the photoreceptor 20.

Meanwhile, a transfer medium 80 such as a paper is fed from an unillustrated paper feeder, fed by an unillustrated pair of registration rollers between the photoreceptor 20 and the transferer 50 in synchronization with an end of the image and the toner image is transferred onto the recording medium [transfer process]. The transferer 50 is preferably applied with a potential reverse to that of a toner as a transfer bias. Then, the transfer medium 80 is separated from the photoreceptor 20 and a transferred image is obtained.

The toner remaining on the photoreceptor 20 is collected by a cleaning blade of the cleaner 61 as a cleaning member to a toner collection chamber 62 in the cleaner 60 [cleaning process].

The collected toner may be transferred by an unillustrated toner recycler to the developer container (46 in FIG. 6) and/or the toner hopper 45 and reused. Numeral 47 is a developer stirrer.

The image forming apparatus may include plural image developers mentioned above, sequentially transfer toner images onto a transfer medium, and transfer the transfer medium to a fixer to fix the toner images with heat, and may transfer plural toner images onto an intermediate transfer medium, transfer the toner images at a time, and fix them as mentioned above [fixing process].

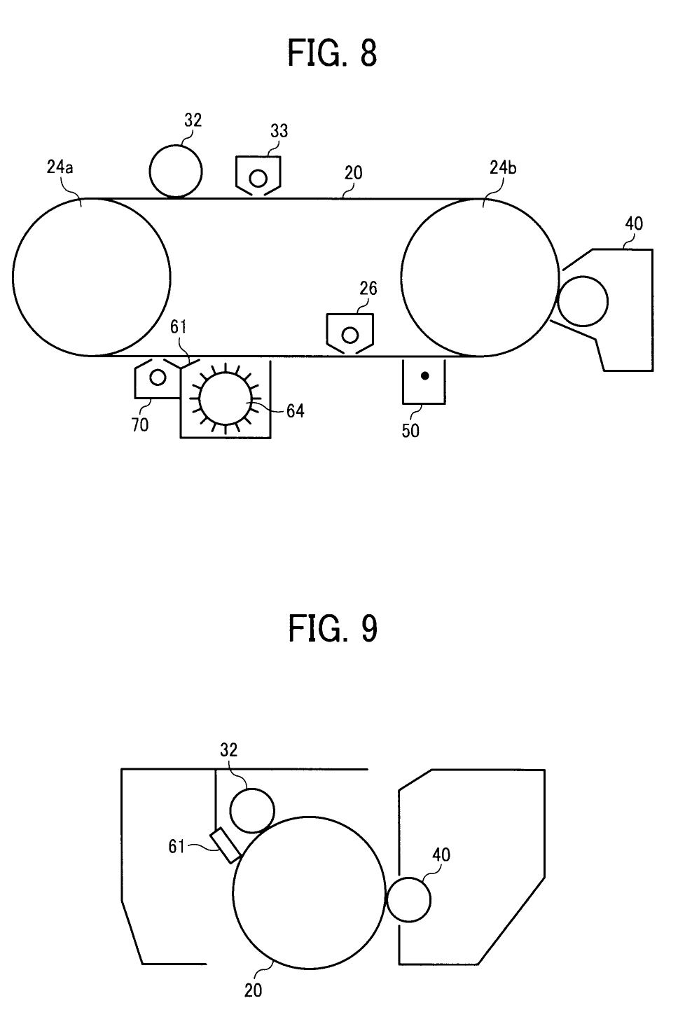

FIG. 8 is a schematic view illustrating another embodiment of image forming apparatus used in the present invention. In FIG. 8, a photoreceptor 20 includes at least a photosensitive layer on an electroconductive substrate, and is driven by drive rollers 24a and 24b. Charging using a charger 32, imagewise exposure using an imagewise light irradiating device 33, developing using an image developer 40, transferring using a transferer 50, pre-cleaning using a light source 26, cleaning using a cleaning brush 64 and a cleaning blade 61 and discharging using a discharge lamp 70 are repeatedly performed. In FIG. 8, the pre-cleaning light irradiating is performed from the side of the substrate of the photoreceptor 20. In this case, the substrate has translucency.

The process cartridge of the present inventions which is detachable from an image forming apparatus includes at least an image bearer and an image developer developing an electrostatic latent image formed on the image bearer with a toner or a developer including a toner and a carrier to form a visual image, using the above-mentioned electrophotographic image forming method.

FIG. 9 is a schematic view illustrating an embodiment of process cartridge used in the present invention.

The process cartridge in FIG. 9 is detachable from an image forming apparatus and includes at least a photoreceptor 20, a brush-shaped contact charger 32, an image developer 40 including the above-mentioned developer and a cleaning blade 61 as a cleaner in a body. In the present invention, the above-mentioned electrophotographic image forming components are combined as a process cartridge, and which is detachable from an image forming apparatus such as copiers and a printers.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Preparations of Polyester Resins A to K

According to compositions in Tables 1-1 to 1-3, monomers selected from aromatic diol, ethylene glycol, glycerin, adipic acid, terephthalic acid, isophthalic acid and itaconic acid were placed in an autoclave having a distillation column and a capacity of 5 litter in an amount of 4,000 g. After they were esterified at 170 to 260° C. under normal pressure without a catalyst, 400 ppm of antimony trioxide were added to the reactant relative to total carboxylic acid components. Under vacuum of 3 Torr, the reactant is polycondensed at 250° C. while glycol was excluded to prepare a resin. The reaction continued until a stirring torque became 10 kg·cm (100 ppm), and was stopped after the reactant was released from being depressurized.

TABLE 1-1

| | | Poly- | Poly- | Poly- | Poly- |
|---|---|---|---|---|---|
| Polyester Composition | | ester A | ester B | ester C | ester D |
| Alcohol | BPA-PO (mol %) | 58 | 57 | 62 | 59 |
| | BPA-EO (mol %) | | | — | — |
| | Ethylene glycol | 41 | 42 | 38 | 41 |
| | (mol %) | | | | |
| | Glycerin (mol %) | 1 | 1 | — | — |
| Carboxylic | Adipic acid | 7 | 7 | 5 | 4 |
| acid | (mol %) | | | | |
| | Terephthalic acid | 55 | 55 | 55 | 56 |
| | (mol %) | | | | |
| | Isophthalic acid | 38 | 38 | 40 | 39 |
| | (mol %) | | | | |
| | Trimellitic acid | | | — | 1 |
| | (mol %) | | | | |
| Polyester | Tg (° C.) | 60.6 | 61.4 | 64.0 | 67.5 |
| properties | Loss tangent | 170.5 | 163.2 | 143.0 | 156.5 |
| | peak temperature | | | | |
| | (° C.) | | | | |
| | Acid value | 6.5 | 6.7 | 7.0 | 6.6 |
| | (mg/KOH/g) | | | | |
| | Molecular | 19400 | 19700 | 15300 | 18700 |
| | weight (weight- | | | | |
| | average) | | | | |
| | Molecular | 4400 | 4400 | 3800 | 4900 |
| | weight (number- | | | | |
| | average) | | | | |

TABLE 1-2

| | | Poly- | Poly- | Poly- | Poly- |
|---|---|---|---|---|---|
| Polyester Composition | | ester E | ester F | ester G | ester H |
| Alcohol | BPA-PO (mol %) | 56 | 60 | 60 | 61 |
| | BPA-EO (mol %) | | | | |
| | Ethylene glycol | 42 | 38 | 39 | 37 |
| | (mol %) | | | | |
| | Glycerin (mol %) | 2 | 2 | 1 | 2 |
| Carboxylic | Adipic acid | 7 | 5 | 5 | 5 |
| acid | (mol %) | | | | |
| | Terephthalic acid | 55 | 55 | 55 | 55 |
| | (mol %) | | | | |
| | Isophthalic acid | 38 | 40 | 40 | 40 |
| | (mol %) | | | | |
| | Trimellitic acid | | | | |
| | (mol %) | | | | |
| Polyester | Tg (° C.) | 61.3 | 61.2 | 62.0 | 60.4 |
| properties | Loss tangent | 165.9 | 146.4 | 136.4 | 153.7 |
| | peak temperature | | | | |
| | (° C.) | | | | |
| | Acid value | 6.8 | 6.7 | 6.8 | 6.5 |
| | (mg/KOH/g) | | | | |
| | Molecular | 19900 | 19100 | 19200 | 18800 |
| | weight (weight- | | | | |
| | average) | | | | |
| | Molecular | 4400 | 4400 | 4300 | 4400 |
| | weight (number- | | | | |
| | average) | | | | |

TABLE 1-3

| Polyester Composition | | Polyester I | Polyester J | Polyester K |
|---|---|---|---|---|
| Alcohol | BPA-PO (mol %) | 55 | — | — |
| | BPA-EO (mol %) | | 55 | 52 |
| | Ethylene glycol | 42 | 40 | 41 |
| | (mol %) | | | |
| | Glycerin (mol %) | 3 | 5 | 7 |
| Carboxylic | Adipic acid | 7 | 5 | 4 |
| acid | (mol %) | | | |
| | Terephthalic acid | 55 | 55 | 55 |
| | (mol %) | | | |
| | Isophthalic acid | 38 | 40 | 41 |
| | (mol %) | | | |
| | Trimellitic acid | | — | — |
| | (mol %) | | | |
| Polyester | Tg (° C.) | 61.2 | 60.3 | 62.4 |
| properties | Loss tangent | 168.6 | 137.0 | 111.0 |
| | peak temperature | | | |
| | (° C.) | | | |
| | Acid value | 6.8 | 6.8 | 7.0 |
| | (mg/KOH/g) | | | |
| | Molecular | 20200 | 19840 | 20800 |
| | weight (weight- | | | |
| | average) | | | |
| | Molecular | 4300 | 3580 | 3580 |
| | weight (number- | | | |
| | average) | | | |

BPA-PO: Polyoxypropylene(2,3)-2,2-bis(4-hydroxyphenyl)propane
BPA-EO: Polyoxyethylene(2,3)-2,2-bis(4-hydroxyphenyl)propane

A glass transition temperature (Tg), a loss tangent peak temperature, an acid value, a number-average molecular weight (Mn) and a weight-average molecular weight (Mw) of each of the polyester resins A to K were measured by the following methods.

<Softening Point>

A load of 1.96 Mpa was applied to 1 g of a sample with a plunger of a flow tester CFT-500D from Shimadzu Corp. while heated at 6° C./min, and pushed out from a nozzle having a diameter of 1 mm and a length of 1 mm. A temperature at which a half of the sample was flowed out was determined as a softening point.

<Glass Transition Temperature (Tg)>

0.01 to 0.02 g of a sample were placed on an aluminum pan of a differential scanning calorimeter DSC-210 from Seiko Instruments Inc., heated up to 200° C., cooled to 0° C. at 10° C./min, and heated at 10° C./min. An intersection between an extended line of a base line not higher than endothermic maximum peak temperature and a tangent line representing a maximum slope from a peak rise up part to a peak summit was determined as a Tg.

<Acid Value>

The acid value was measured according to JIS K0070 method. However, only the measurement solvent was changed to a mixed solvent including acetone and toluene (1:1) from specified ethanol and ether.

<Loss Tangent Peak Temperature>

0.8 g of a toner is cast with a dice having a diameter of 20 mm at a pressure of 30 Mpa. The loss elastic modulus (G″), the storage modulus (G′) and the loss tangent (tan δ) were measured by Advanced Rheometric Expansion System from TA Instrument, USA with a parallel cone having a diameter of 20 mm under the following conditions:

Frequency: 1.0 Hz

Heating speed: 2.0° C./min

Distortion: 0.1% (automatic distortion control: allowable minimum stress 1.0 g/cm, allowable maximum stress 500 g/cm, maximum additional distortion 200% and distortion adjustment 200%)

Gap: in a force range of from 0 to 100 gm after setting a sample

When the storage modulus (G′) is 10 or less, the loss tangent (tan δ) is excluded.

<Molecular Weight>

The number-average molecular weight and weight-average molecular weight of the binder resin is measured by a GPC measurer GPC-150C from Waters Corp. A column (KF801 to 807 from Shodex) is stabilized in a heat chamber having a temperature of 40° C.; THF is put into the column at a speed of 1 ml/min as a solvent; a sample having a concentration of from 0.05 to 0.6% by weight, is put into the column to measure a molecular weight distribution of the binder resin. From the molecular weight distribution thereof, the weight-average molecular weight and the number-average molecular weight of the binder resin are determined by using a calibration curve which is previously prepared using several polystyrene standard samples having a single distribution peak.

As the standard polystyrene samples for making the calibration curve, for example, the samples having a molecular weight of 6×10², 2.1×10³, 4×10³, 1.75×10⁴, 5.1×10⁴, 1.1×10⁵, 3.9×10⁵, 8.6×10⁵, 2×10⁶ and 48×10⁶ from Pressure Chemical Co. or Tosoh Corporation are used. It is preferable to use at least 10 standard polystyrene samples. In addition, an RI (refraction index) detector is used as the detector.

[Preparation of Crystalline Polyester Resin A]

4,000 g of compositions in the following Table 2 and 4 g of hydroquinone were placed in four-neck round bottomed flask having a thermometer, a stirrer, a condenser, a nitrogen inlet pipe and a capacity of 5 L. The flask was set in a mantle heater and a nitrogen gas introduced therein from the nitrogen inlet pipe, and the flask was heated while maintaining the inside thereof under an inactive atmosphere. The reaction was continued for 5 hrs at 160° C., 1 hr at 200° C. and 1 hr at 8.3 kPa to prepare polyester A. The polyester A had a softening point of 70° C.

TABLE 2

| Composition of | | Crystalline Polyester |
|---|---|---|
| Crystalline | Polyester Resin | Resin A |
| Alcohol | 1,4-butanediol (mol %) | 100 |
| Carboxylic acid | Fumaric acid (mol %) | 90 |
| | Succinic acid (mol %) | 5 |
| | Trimellitic acid (mol %) | 5 |
| Polyester property | Softening point (° C.) | 70 |

[Preparation of Toner]

### (Preparation of Transparent Toner 1)

| | |
|---|---|
| Polyester resin A | 100 |
| Crystalline polyester A | 10 |
| Carnauba wax | 5 |
| (Carnauba Wax No. 1 from Cerarica Noda Co., Ltd.) | |
| N,N′-ethylene-bis stearic acid amide | 2 |
| (EB-P from Kao Corp.) | |

After the above-mentioned toner raw materials had been preliminarily mixed by using a Henschel Mixer (FM20B from Nippon Coke & Engineering. Co., Ltd.), the resulting mixture was melt-kneaded at a temperature in a range from 100 to 130° C. by a twin-screw kneader (PCM-30 from Ikegai Corporation). After having been cooled to room temperature, the resulting kneaded matter was coarsely pulverized into 200 to 300 μm by using a hummer mill. Next, by using a ultrasonic jet pulverizer Labojet (from Nippon Pneumatic Mfg. Co., Ltd.), this was finely pulverized, and was then classified by a stream classifier (MDS-I from Nippon Pneumatic Mfg. Co., Ltd.), with the louver opening being adjusted on demand, so as to have a weight average particle size in a range from 5.6±0.2 μm to prepare mother toner particles. Next, 1.0 part by weight of an additive (HDK-2000 from Clamant) was stirred and mixed with 100 parts by weight of the mother toner particles by a Henschel mixer to prepare a transparent toner 1.

(Preparation of Transparent Toner 2)

| | |
|---|---|
| Polyester resin B | 100 |
| Crystalline polyester A | 10 |
| Carnauba wax | 5 |
| (Carnauba Wax No. 1 from Cerarica Noda Co., Ltd.) | |
| N,N′-ethylene-bis stearic acid amide | 2 |
| (EB-P from Kao Corp.) | |

The procedure for preparation of the transparent toner 1 was repeated except for using the above-mentioned toner raw materials to prepare a transparent toner 2.

(Preparation of Transparent Toner 3)

| | |
|---|---|
| Polyester resin C | 100 |
| Crystalline polyester A | 5 |
| Carnauba wax | 5 |
| (Carnauba Wax No. 1 from Cerarica Noda Co., Ltd.) | |
| N,N′-ethylene-bis stearic acid amide | 2 |
| (EB-P from Kao Corp.) | |

The procedure for preparation of the transparent toner 1 was repeated except for using the above-mentioned toner raw materials to prepare a transparent toner 3.

(Preparation of Transparent Toner 4)

| | |
|---|---|
| Polyester resin C | 100 |
| Crystalline polyester A | 15 |
| Carnauba wax | 5 |
| (Carnauba Wax No. 1 from Cerarica Noda Co., Ltd.) | |
| N,N′-ethylene-bis stearic acid amide | 2 |
| (EB-P from Kao Corp.) | |

The procedure for preparation of the transparent toner 1 was repeated except for using the above-mentioned toner raw materials to prepare a transparent toner 4.

(Preparation of Transparent Toner 5)

| | |
|---|---|
| Polyester resin D | 100 |
| Crystalline polyester A | 5 |
| Carnauba wax | 5 |
| (Carnauba Wax No. 1 from Cerarica Noda Co., Ltd.) | |
| N,N′-ethylene-bis stearic acid amide | 2 |
| (EB-P from Kao Corp.) | |

The procedure for preparation of the transparent toner 1 was repeated except for using the above-mentioned toner raw materials to prepare a transparent toner 5.

(Preparation of Transparent Toner 6)

| | |
|---|---|
| Polyester resin D | 100 |
| Crystalline polyester A | 10 |
| Carnauba wax | 5 |
| (Carnauba Wax No. 1 from Cerarica Noda Co., Ltd.) | |
| N,N′-ethylene-bis stearic acid amide | 2 |
| (EB-P from Kao Corp.) | |

The procedure for preparation of the transparent toner 1 was repeated except for using the above-mentioned toner raw materials to prepare a transparent toner 6.

(Preparation of Transparent Toner 7)

| | |
|---|---|
| Polyester resin E | 100 |
| Crystalline polyester A | 2 |
| Carnauba wax | 5 |
| (Carnauba Wax No. 1 from Cerarica Noda Co., Ltd.) | |
| N,N′-ethylene-bis stearic acid amide | 2 |
| (EB-P from Kao Corp.) | |

The procedure for preparation of the transparent toner 1 was repeated except for using the above-mentioned toner raw materials to prepare a transparent toner 7.

(Preparation of Transparent Toner 8)

| | |
|---|---|
| Polyester resin E | 100 |
| Crystalline polyester A | 5 |
| Carnauba wax | 5 |
| (Carnauba Wax No. 1 from Cerarica Noda Co., Ltd.) | |
| N,N′-ethylene-bis stearic acid amide | 2 |
| (EB-P from Kao Corp.) | |

The procedure for preparation of the transparent toner 1 was repeated except for using the above-mentioned toner raw materials to prepare a transparent toner 8.

(Preparation of Transparent Toner 9)

| | |
|---|---|
| Polyester resin F | 100 |
| Crystalline polyester A | 20 |
| Carnauba wax | 5 |
| (Carnauba Wax No. 1 from Cerarica Noda Co., Ltd.) | |
| N,N′-ethylene-bis stearic acid amide | 2 |
| (EB-P from Kao Corp.) | |

The procedure for preparation of the transparent toner 1 was repeated except for using the above-mentioned toner raw materials to prepare a transparent toner 9.

(Preparation of Transparent Toner 10)

| | |
|---|---|
| Polyester resin F | 100 |
| Crystalline polyester A | 15 |
| Carnauba wax | 5 |
| (Carnauba Wax No. 1 from Cerarica Noda Co., Ltd.) | |
| N,N′-ethylene-bis stearic acid amide | 2 |
| (EB-P from Kao Corp.) | |

The procedure for preparation of the transparent toner 1 was repeated except for using the above-mentioned toner raw materials to prepare a transparent toner 10.

(Preparation of Transparent Toner 11)

| | |
|---|---|
| Polyester resin G | 100 |
| Crystalline polyester A | 15 |
| Carnauba wax | 7 |
| (Carnauba Wax No. 1 from Cerarica Noda Co., Ltd.) | |
| N,N′-ethylene-bis stearic acid amide | 2 |
| (EB-P from Kao Corp.) | |

The procedure for preparation of the transparent toner 1 was repeated except for using the above-mentioned toner raw materials to prepare a transparent toner 11.

(Preparation of Transparent Toner 12)

| | |
|---|---|
| Polyester resin G | 100 |
| Crystalline polyester A | 10 |
| Carnauba wax | 7 |
| (Carnauba Wax No. 1 from Cerarica Noda Co., Ltd.) | |
| N,N′-ethylene-bis stearic acid amide | 2 |
| (EB-P from Kao Corp.) | |

The procedure for preparation of the transparent toner 1 was repeated except for using the above-mentioned toner raw materials to prepare a transparent toner 12.

(Preparation of Transparent Toner 13)

| | |
|---|---|
| Polyester resin H | 100 |
| Crystalline polyester A | 10 |
| Carnauba wax | 5 |
| (Carnauba Wax No. 1 from Cerarica Noda Co., Ltd.) | |
| N,N′-ethylene-bis stearic acid amide | 2 |
| (EB-P from Kao Corp.) | |

The procedure for preparation of the transparent toner 1 was repeated except for using the above-mentioned toner raw materials to prepare a transparent toner 13.

(Preparation of Transparent Toner 14)

| | |
|---|---|
| Polyester resin H | 100 |
| Crystalline polyester A | 10 |
| Carnauba wax | 5 |
| (Carnauba Wax No. 1 from Cerarica Noda Co., Ltd.) | |
| Stearic acid amide (Stearic acid amide S from Kao Corp.) | 2 |

The procedure for preparation of the transparent toner 1 was repeated except for using the above-mentioned toner raw materials to prepare a transparent toner 14.

(Preparation of Transparent Toner 15)

| | |
|---|---|
| Polyester resin H | 100 |
| Crystalline polyester A | 10 |

The procedure for preparation of the transparent toner 1 was repeated except for using the above-mentioned toner raw materials to prepare a transparent toner 15.

(Preparation of Transparent Toner 16)

| | |
|---|---|
| Polyester resin H | 100 |
| Carnauba wax | 5 |
| (Carnauba Wax No. 1 from Cerarica Noda Co., Ltd.) | |

The procedure for preparation of the transparent toner 1 was repeated except for using the above-mentioned toner raw materials to prepare a transparent toner 16.

(Preparation of Transparent Toner 17)

First, 100 parts of water, 10 parts of an aqueous dispersion solution of a vinyl-based resin (copolymer of styrene-methacrylic acid-butyl acrylate-sodium salt of an adduct of a sulfuric ester with ethyleneoxide methacrylate) (made by Sanyo Chemical Industries, Ltd., solid components: 20%), 20 parts of a 50% aqueous solution of dodecyldiphenylether sodium disulfonate (ELEMINOL MON-7, made by Sanyo Chemical Industries, Ltd., solid components: 20%), 40 parts of a 1% aqueous solution of carboxymethylcellulose serving as a polymer protective colloid (Cellogen BSH, made by Sanyo Chemical Industries, Ltd.), and 15 parts of ethyl acetate were mixed and stirred so that a solution having a milky white color was obtained. This was used as an aqueous phase.

To a container equipped with a stirring bar and a thermometer, 230 parts of the polyester resin I, 40 parts of a crystalline polyester resin A, 40 parts of carnauba wax (Carnauba Wax No. 1 from Cerarica Noda Co., Ltd.) and 200 parts of ethyl acetate were loaded, and they were heated to 80° C. under stirring, and after having been maintained at 80° C. for 5 hours, the mixture was cooled to 30° C. over 1 hour, and by using a bead mill (Ultra Visco Mill made by AIMEX Co., Ltd.) under the following conditions: liquid feeding speed of 1.2 Kg/hr, peripheral disc speed of 10 msec, an amount of filling zirconia beads having 0.5 mm diameter of 80% by volume, and the number of passes of 5 times, the wax was dispersed to prepare a wax dispersion.

Next, 1250 parts of the aqueous phase, 1130 parts of the wax dispersion solution, 1 part of isobutyl alcohol, 7 parts of isophoronediamine and 5 parts of an emulsion stabilizer UCAT660M (made by Sanyo Chemical Industries, Ltd.) were put into a container, and they were mixed by a TK-type homomixer (made by PRIMIX Corporation) at 9,000 rpm for 30 minutes under an ambient temperature of 28° C. to prepare an aqueous medium dispersion.

Thereafter, the aqueous medium dispersion was heated to 58° C., and it was further dispersed and mixed by using the TK-type homomixer at a rotation speed of 1,500 rpm for 1 hour to prepare an emulsified slurry.

The above-mentioned emulsified slurry was loaded into a container equipped with a stirring bar and a thermometer, and after having been subjected to a de-solvent process at 35° C. for 10 hours, the slurry was matured at 45° C. for 12 hours so that a dispersion solution from which the organic solvent had been distilled off was obtained. After 100 parts of the dispersion solution had been filtered under reduced pressure, 300 parts of ion exchange water was added to the filtered cake, and after having been stirred by using the TK-type homomixer at a rotation speed of 6,000 rpm for 15 minutes, the mixture was filtered under reduced pressure. Thereafter, 100 parts of a 10% aqueous solution of sodium hydroxide was added to the filtered cake, and after having been stirred by the TK-type homomixer at a rotation speed of 6,000 rpm for 15 minutes, the mixture was filtered under reduced pressure. Thereafter, 100 parts of a 10% hydrochloric acid solution was added to the filtered cake, and after having been stirred by the TK-type homomixer at a rotation speed of 6,000 rpm for 15 minutes, the mixture was filtered under reduced pressure. To the filtered cake was then added 500 parts of ion exchange water, and after having been stirred by the TK-type homomixer at a rotation speed of 6,000 rpm for 30 minutes, the mixture was filtered under reduced pressure to prepare a filtered cake.

The filtered cake was dried by an air dryer at 40° C. for 24 hours, and sieved by a mesh having an opening of 75 μm to prepare mother toner base particles.

Next, 1.0 part by weight of an additive (HDK-2000 from Clariant) was stirred and mixed with 100 parts by weight the mother toner particles by a Henschel mixer to prepare a transparent toner 17.

(Preparation of Transparent Toner 18)

| | |
|---|---|
| Polyester resin J | 100 |
| Crystalline polyester A | 15 |
| Carnauba wax | 5 |
| (Carnauba Wax No. 1 from Cerarica Noda Co., Ltd.) | |
| N,N′-ethylene-bis stearic acid amide | 2 |
| (EB-P from Kao Corp.) | |

The procedure for preparation of the transparent toner 1 was repeated except for using the above-mentioned toner raw materials to prepare a transparent toner 18.

(Preparation of Transparent Toner 19)

| | |
|---|---|
| Polyester resin K | 100 |
| Crystalline polyester A | 15 |
| Carnauba wax | 5 |
| (Carnauba Wax No. 1 from Cerarica Noda Co., Ltd.) | |
| N,N′-ethylene-bis stearic acid amide | 2 |
| (EB-P from Kao Corp.) | |

The procedure for preparation of the transparent toner 1 was repeated except for using the above-mentioned toner raw materials to prepare a transparent toner 19.

The properties of the transparent toners 1 to 19 are shown in Tables 3-1 to 3-3.

TABLE 3-1

| | Weight-average | | |
|---|---|---|---|
| | particle diameter | Loss tangent peak | |
| | [μm] | temperature [° C.] | Loss tangent |
| Transparent toner 1 | 5.5 | 120 | 2 |
| Transparent toner 2 | 5.6 | 118 | 4 |
| Transparent toner 3 | 5.6 | 85 | 4 |
| Transparent toner 4 | 5.7 | 78 | 5 |
| Transparent toner 5 | 5.4 | 156 | 11 |
| Transparent toner 6 | 5.5 | 164 | 11 |
| Transparent toner 7 | 5.6 | 125 | 5 |
| Transparent toner 8 | 5.6 | 127 | 5 |
| Transparent toner 9 | 5.5 | 91 | 9 |
| Transparent toner 10 | 5.6 | 95 | 8 |
| Transparent toner 11 | 5.6 | 88 | 10 |
| Transparent toner 12 | 5.5 | 92 | 9 |
| Transparent toner 13 | 5.6 | 98 | 6 |
| Transparent toner 14 | 5.4 | 101 | 5 |
| Transparent toner 15 | 5.6 | 132 | 4 |
| Transparent toner 16 | 5.4 | 145 | 4 |
| Transparent toner 17 | 5.7 | 111 | 7 |
| Transparent toner 18 | 5.5 | 84 | 28 |
| Transparent toner 19 | 5.5 | 82 | 50 |

TABLE 3-2

| | Maximum G′ at | Minimum G′ at | |
|---|---|---|---|
| | from | from | Minimum G′ at |
| | 120 to 160° C. | 120 to 160° C. | from 70 to 90° C. |
| | [Pa] | [Pa] | [Pa] |
| Transparent toner 1 | 2 × 10³ | 3 × 10² | 2 × 10⁵ |
| Transparent toner 2 | 3 × 10³ | 4 × 10² | 3 × 10⁵ |
| Transparent toner 3 | 7 × 10² | 5 × 10 | 3 × 10⁵ |
| Transparent toner 4 | 4 × 10² | 3 × 10 | 1 × 10⁵ |
| Transparent toner 5 | 7 × 10³ | 2 × 10² | 7 × 10⁵ |
| Transparent toner 6 | 9 × 10³ | 9 × 10 | 2 × 10⁶ |
| Transparent toner 7 | 4 × 10⁴ | 2 × 10 | 1 × 10⁶ |
| Transparent toner 8 | 9 × 10³ | 1 × 10 | 9 × 10⁵ |
| Transparent toner 9 | 2 × 10² | 3 × 10 | 5 × 10⁵ |
| Transparent toner 10 | 4 × 10² | 2 | 6 × 10⁵ |
| Transparent toner 11 | 3 × 10³ | 6 × 10 | 8 × 10⁴ |
| Transparent toner 12 | 5 × 10³ | 8 × 10 | 2 × 10⁵ |
| Transparent toner 13 | 4 × 10³ | 4 × 10 | 4 × 10⁵ |
| Transparent toner 14 | 8 × 10² | 1 × 10² | 3 × 10⁵ |
| Transparent toner 15 | 1 × 10³ | 2 × 10² | 2 × 10⁵ |
| Transparent toner 16 | 8 × 10³ | 2 × 10³ | 6 × 10⁵ |
| Transparent toner 17 | 2 × 10³ | 1 × 10² | 2 × 10⁵ |
| Transparent toner 18 | 9 × 10² | 4 × 10 | 3 × 10⁵ |
| Transparent toner 19 | 8 × 10² | 3 × 10 | 4 × 10⁵ |

TABLE 3-3

| | | Crystalline | |
|---|---|---|---|
| | Wax | polyester | Fatty acid amide lubricant |
| Transparent toner 1 | Yes | Yes | N,N′-ethylene-bis stearic |
| | | | acid amide |
| Transparent toner 2 | Yes | Yes | N,N′-ethylene-bis stearic |
| | | | acid amide |
| Transparent toner 3 | Yes | Yes | N,N′-ethylene-bis stearic |
| | | | acid amide |
| Transparent toner 4 | Yes | Yes | N,N′-ethylene-bis stearic |
| | | | acid amide |
| Transparent toner 5 | Yes | Yes | N,N′-ethylene-bis stearic |
| | | | acid amide |
| Transparent toner 6 | Yes | Yes | N,N′-ethylene-bis stearic |
| | | | acid amide |
| Transparent toner 7 | Yes | Yes | N,N′-ethylene-bis stearic |
| | | | acid amide |
| Transparent toner 8 | Yes | Yes | N,N′-ethylene-bis stearic |
| | | | acid amide |
| Transparent toner 9 | Yes | Yes | N,N′-ethylene-bis stearic |
| | | | acid amide |
| Transparent toner 10 | Yes | Yes | N,N′-ethylene-bis stearic |
| | | | acid amide |
| Transparent toner 11 | Yes | Yes | N,N′-ethylene-bis stearic |
| | | | acid amide |
| Transparent toner 12 | Yes | Yes | N,N′-ethylene-bis stearic |
| | | | acid amide |
| Transparent toner 13 | Yes | Yes | N,N′-ethylene-bis stearic |
| | | | acid amide |
| Transparent toner 14 | Yes | Yes | Stearic acid amide |
| Transparent toner 15 | No | Yes | No |
| Transparent toner 16 | Yes | No | No |
| Transparent toner 17 | Yes | Yes | No |
| Transparent toner 18 | Yes | Yes | N,N′-ethylene-bis stearic |
| | | | acid amide |
| Transparent toner 19 | Yes | Yes | N,N′-ethylene-bis stearic |
| | | | acid amide |

[Preparation of Masterbatch]

50 parts of carbon black (Regal 400R from Cabot Corp.) and 50 parts of a polyester resin (RS801 from Sanyo Chemical Industries, Ltd.) were mixed in 30 parts of water by HENSCHEL MIXER (from Nippon Coke & Engineering Co., Ltd.) to prepare a mixture. The mixture was kneaded by a two-roll mill at 160° C. for 50 min to prepare a kneaded mixture, the kneaded mixture was expanded upon application of pressure and cooled to prepare a solidified mixture, and the solidified mixture was pulverized to prepare a black masterbatch 1. The procedure for preparation of the black masterbatch 1 was repeated to prepare a magenta masterbatch 1, a cyan masterbatch 1 and a yellow masterbatch 1 except for replacing the carbon black with C.I. Pigment Red 269, C.I. Pigment Blue 15:3 and C.I. Pigment Yellow 155, respectively.

[Preparation of Color Toner]

| | |
|---|---|
| Polyester resin I | 92 |
| Crystalline polyester A | 15 |
| Carnauba wax | 4 |
| (Carnauba Wax No. 1 from Cerarica Noda Co., Ltd.) | |
| Stearic acid amide (Stearic acid amide S from Kao Corp.) | 2 |
| Black masterbatch 1 | 16 |

The procedure for preparation of the transparent toner 1 was repeated except for using the above-mentioned toner raw materials to prepare a black toner 1.

Further, the procedure for preparation of the black toner 1 was repeated except for using the magenta masterbatch 1, the cyan masterbatch 1 and the yellow masterbatch 1 to prepare a magenta toner 1, a cyan toner 1 and a yellow toner 1.

### Example 1

Each of 5% by weight of the transparent toner 1 and the color toners and 95% by weight of a coated ferrite carrier were uniformly mixed at 48 rpm for 5 minutes by using a turbular mixer (from Willy A. Bachofen (WAB) AG) to be charged to prepare a transparent developer 1, a black developer 1, a magenta developer 1, a cyan developer 1 and a yellow developer 1.

The transparent developer 1 was contained in the developing unit 105E in FIG. 5, and the yellow developer 1, the magenta developer 1, the cyan developer 1 and the black developer 1 were contained in the developing units 105A to 105D, respectively.

<Glossiness>

Using the image forming apparatus in FIG. 5, a color toner solid image having an adherence amount of 0.4 mg/cm² was formed on a paper having an average roughness Ra of 0.7 μm at a fixing linear velocity of 160 mm/sec, a fixing temperature of 130° C. with a NIP width of 11 mm. After an average length Sm of concavities and convexities on the surface of the color toner solid image was measured, a transparent toner solid image having a thickness of 7 μm was formed on a part thereof at a fixing linear velocity of 160 mm/sec, a fixing temperature of 160° C. with a NIP width of 11 mm. An average length Sm of concavities and convexities on the surface of the transparent toner image, and glossiness of the transparent toner image and the color toner image were measured. The transparent toner image needs to have glossiness not less than 40% and a difference in glossiness between the transparent toner image and the color toner image needs to be not less than 15 point.

<Fixability>

Using the image forming apparatus in FIG. 5, fixing temperature of the transparent toner image was changed to determine a cold offset temperature (minimum fixable temperature) and a hot offset temperature (hot offset resistant temperature) thereof for evaluating low-temperature fixability and hot offset resistance thereof.

[Low-Temperature Fixability]

Excellent: less than 130° C.

Good: not less than 130° C. less than 145° C.

Passable: not less than 145° C. less than 160° C.

Poor: not less than 160° C.

[Hot Offset Resistance]

Excellent: not less than 200° C.

Good: not less than 185° C. less than 200° C.

Passable: not less than 170° C. less than 185° C.

Poor: less than 170° C.

<Storage Stability>

Each of 10 g of toners was put into a screw vial bottle (30 ml), and after having been subjected to tapping processes of 100 times by using a tapping machine, it was kept in a thermostatic chamber at 45° C. for 24 hrs, and then returned to room temperature, and subjected to measurements on a penetration by using a penetrometer. When a penetration of 10 mm or less, the toner was evaluated as poor. 10 to 15 mm, passable. 15 to 20 mm, good. Not less than 20 mm, excellent.

### Comparative Example 1

The procedure for evaluation in Example 1 was repeated except for changing the adherence amount to 0.8 mg/cm² and the average roughness Ra to 0.2 μm.

### Example 2

The procedure for evaluation in Example 1 was repeated except for changing the fixing temperature to 150° C., the adherence amount to 0.8 mg/cm² and the average roughness Ra to 0.2 μm.

### Example 3

The procedure for evaluation in Example 1 was repeated except for changing the fixing temperature to 150° C., the adherence amount to 0.6 mg/cm² and the average roughness Ra to 0.7 μm.

### Example 4

The procedure for evaluation in Example 1 was repeated except for changing the fixing temperature to 140° C., the adherence amount to 0.6 mg/cm² and the average roughness Ra to 0.7 μm.

### Example 5

The procedure for evaluation in Example 1 was repeated except for changing the average roughness Ra to 1.7 μm.

### Comparative Example 2

The procedure for evaluation in Example 1 was repeated except for changing the fixing temperature to 120° C. and the average roughness Ra to 1.7 μm.

### Examples 6 to 23

The procedure for evaluation in Example 1 was repeated except for using the transparent toners 2 to 19.

### Example 24

The procedure for evaluation in Example 1 was repeated except for changing the thickness of the transparent toner image to 0.8 μm.

### Example 25

The procedure for evaluation in Example 1 was repeated except for changing the thickness of the transparent toner image to 1.2 μm.

### Example 26

The procedure for evaluation in Example 1 was repeated except for changing the thickness of the transparent toner image to 14 μm.

### Example 27

The procedure for evaluation in Example 1 was repeated except for changing the thickness of the transparent toner image to 16 μm.

The evaluation results of Examples 1 to 27 and Comparative Examples 1 and 2 are shown in Tables 4-1 and 4-2.

TABLE 4-1

| | | Background | Background | Transparent | Transparent |
|---|---|---|---|---|---|
| | | toner image | toner image | toner image | toner image |
| | Transparent | surface Sm | glossiness | glossiness | thickness |
| | toner | [μm] | [%] | [%] | [μm] |
| Example 1 | Transparent | 148 | 21 | 54 | 7 |
| | toner 1 | | | | |
| Comparative | Transparent | 354 | 51 | 62 | 7 |
| Example 1 | toner 1 | | | | |
| Example 2 | Transparent | 347 | 43 | 61 | 7 |
| | toner 1 | | | | |
| Example 3 | Transparent | 253 | 40 | 59 | 7 |
| | toner 1 | | | | |
| Example 4 | Transparent | 244 | 34 | 58 | 7 |
| | toner 1 | | | | |
| Example 5 | Transparent | 55 | 11 | 51 | 7 |
| | toner 1 | | | | |
| Comparative | Transparent | 48 | 8 | 37* | 7 |
| Example 2 | toner 1 | | | | |
| Example 6 | Transparent | 148 | 21 | 60 | 7 |
| | toner 2 | | | | |
| Example 7 | Transparent | 148 | 21 | 63 | 7 |
| | toner 3 | | | | |
| Example 8 | Transparent | 148 | 21 | 64 | 7 |
| | toner 4 | | | | |
| Example 9 | Transparent | 148 | 21 | 58 | 7 |
| | toner 5 | | | | |
| Example 10 | Transparent | 148 | 21 | 57 | 7 |
| | toner 6 | | | | |
| Example 11 | Transparent | 148 | 21 | 59 | 7 |
| | toner 7 | | | | |
| Example 12 | Transparent | 148 | 21 | 62 | 7 |
| | toner 8 | | | | |
| Example 13 | Transparent | 148 | 21 | 75 | 7 |
| | toner 9 | | | | |
| Example 14 | Transparent | 148 | 21 | 73 | 7 |
| | toner 10 | | | | |
| Example 15 | Transparent | 148 | 21 | 69 | 7 |
| | toner 11 | | | | |
| Example 16 | Transparent | 148 | 21 | 67 | 7 |
| | toner 12 | | | | |
| Example 17 | Transparent | 148 | 21 | 76 | 7 |
| | toner 13 | | | | |
| Example 18 | Transparent | 148 | 21 | 78 | 7 |
| | toner 14 | | | | |
| Example 19 | Transparent | 148 | 21 | 75 | 7 |
| | toner 15 | | | | |
| Example 20 | Transparent | 148 | 21 | 70 | 7 |
| | toner 16 | | | | |
| Example 21 | Transparent | 148 | 21 | 73 | 7 |
| | toner 17 | | | | |
| Example 22 | Transparent | 148 | 21 | 80 | 7 |
| | toner 18 | | | | |
| Example 23 | Transparent | 148 | 21 | 85 | 7 |
| | toner 19 | | | | |
| Example 24 | Transparent | 148 | 21 | 47 | 0.8 |
| | toner 1 | | | | |
| Example 25 | Transparent | 148 | 21 | 50 | 1.2 |
| | toner 1 | | | | |
| Example 26 | Transparent | 148 | 21 | 58 | 14 |
| | toner 1 | | | | |
| Example 27 | Transparent | 148 | 21 | 53 | 16 |
| | toner 1 | | | | |

TABLE 4-2

| | | Glossi- | Low- | | |
|---|---|---|---|---|---|
| | | ness | tempera- | | |
| | Transparent | contrast | ture | Hot offset | Storage |
| | toner | [point] | fixability | resistance | stability |
| Example 1 | Transparent | 33 | Good | Passable | Good |
| | toner 1 | | | | |
| Comparative | Transparent | 11* | Good | Passable | Good |
| Example 1 | toner 1 | | | | |
| Example 2 | Transparent | 18 | Good | Passable | Good |
| | toner 1 | | | | |
| Example 3 | Transparent | 19 | Good | Passable | Good |
| | toner 1 | | | | |
| Example 4 | Transparent | 24 | Good | Passable | Good |
| | toner 1 | | | | |
| Example 5 | Transparent | 40 | Good | Passable | Good |
| | toner 1 | | | | |
| Comparative | Transparent | 29 | Good | Passable | Good |
| Example 2 | toner 1 | | | | |
| Example 6 | Transparent | 39 | Good | Good | Good |
| | toner 2 | | | | |
| Example 7 | Transparent | 42 | Excellent | Good | Good |
| | toner 3 | | | | |
| Example 8 | Transparent | 43 | Excellent | Passable | Passable |
| | toner 4 | | | | |
| Example 9 | Transparent | 37 | Good | Excellent | Excellent |
| | toner 5 | | | | |
| Example 10 | Transparent | 36 | Passable | Excellent | Excellent |
| | toner 6 | | | | |
| Example 11 | Transparent | 38 | Passable | Excellent | Excellent |
| | toner 7 | | | | |
| Example 12 | Transparent | 41 | Good | Excellent | Excellent |
| | toner 8 | | | | |
| Example 13 | Transparent | 54 | Excellent | Passable | Good |
| | toner 9 | | | | |
| Example 14 | Transparent | 52 | Excellent | Good | Good |
| | toner 10 | | | | |
| Example 15 | Transparent | 48 | Excellent | Good | Passable |
| | toner 11 | | | | |
| Example 16 | Transparent | 46 | Good | Good | Excellent |
| | toner 12 | | | | |
| Example 17 | Transparent | 55 | Excellent | Excellent | Good |
| | toner 13 | | | | |
| Example 18 | Transparent | 57 | Excellent | Excellent | Excellent |
| | toner 14 | | | | |
| Example 19 | Transparent | 54 | Excellent | Passable | Passable |
| | toner 15 | | | | |
| Example 20 | Transparent | 49 | Good | Excellent | Passable |
| | toner 16 | | | | |
| Example 21 | Transparent | 52 | Excellent | Excellent | Passable |
| | toner 17 | | | | |
| Example 22 | Transparent | 59 | Excellent | Good | Good |
| | toner 18 | | | | |
| Example 23 | Transparent | 64 | Excellent | Passable | Good |
| | toner 19 | | | | |
| Example 24 | Transparent | 26 | Good | Passable | Good |
| | toner 1 | | | | |
| Example 25 | Transparent | 29 | Good | Passable | Good |
| | toner 1 | | | | |
| Example 26 | Transparent | 37 | Good | Passable | Good |
| | toner 1 | | | | |
| Example 27 | Transparent | 32 | Passable | Passable | Good |
| | toner 1 | | | | |

As is clear from Table 4, all of Examples 1 to 27 efficiently present glossiness and enlarge contrast between a part the transparent toner is formed on and a part it is not formed on to enhance glossiness.

Comparative Examples 1 and 2 do not have allowable glossiness in the item marked with *, and which are out of practical use level.

Having now fully described the invention, it will be apparent to one of ordinary skill in the art that many changes and modifications can be made thereto without departing from the spirit and scope of the invention as set forth therein.

What is claimed is:

1. An electrophotographic image forming method, comprising:
fixing one or more chromatic toner images on a recording medium; and
fixing a transparent toner image on the chromatic toner image to partially or wholly increase glossiness of the recording medium,
wherein the chromatic toner image has an average length (Sm) of concavities and convexities of from 50 to 350 μm.

2. The electrophotographic image forming method of claim 1, wherein the chromatic toner images have an average length (Sm) of concavities and convexities of from 50 to 250 μm.

3. The electrophotographic image forming method of claim 1, wherein the transparent toner comprises a lubricant and has a loss tangent having a maxim peak not less than 3 at from 80 to 160° C., which is determined by the following formula (1):
Loss elastic modulus (G″)/Storage elastic modulus (G′)=Loss tangent (tan δ) (1).

4. The electrophotographic image forming method of claim 1, wherein the transparent toner has the storage elastic modulus (G′) of from 1 to 1×10⁴ Pa at from 120 to 160° C.

5. The electrophotographic image forming method of claim 1, wherein the transparent toner further comprises a crystalline polyester.

6. The electrophotographic image forming method of claim 1, wherein the transparent toner has the storage elastic modulus (G′) not less than 1×10⁵ Pa at from 70 to 90° C.

7. The electrophotographic image forming method of claim 1, wherein the transparent toner internally comprises the lubricant comprising an aliphatic amide lubricant.

8. The electrophotographic image forming method of claim 7, wherein the aliphatic amide lubricant is N,N′-ethylene-bis stearic acid amide.

9. The electrophotographic image forming method of claim 1, wherein the transparent toner image has a thickness of from 1 to 15 μm after fixed.

10. A process cartridge detachable from image forming apparatus, comprising:
an image bearer configured to bear an image; and
an image developer configured to develop an electrostatic latent image formed on the image bearer with a toner or a developer comprising a toner and a carrier to form a visual image,
wherein the visual image is formed by the electrophotographic image forming method according to claim 1.
